(19) United States
(12) Patent Application Publication
(10) Pub. No.: US 2023/0015828 A1
(43) Pub. Date: Jan. 19, 2023

(54) APPARATUS AND METHOD FOR COATING A SURFACE OF A WORKPIECE

(71) Applicant: HOMAG GmbH, Schopfloch (DE)

(72) Inventors: Sergej SCHWARZ, Nürnberg (DE); Johannes SCHMID, Starzach (DE); Achim HOMEIER, Pfalzgrafenweiler (DE)

(21) Appl. No.: 17/782,974

(22) PCT Filed: Dec. 4, 2020
(86) PCT No.: PCT/EP2020/084704

§ 371 Date: Jun. 6, 2022

(30) Foreign Application Priority Data
Dec. 6, 2019 (DE) 10 2019 133 335.0

(51) Int. Cl. B27D 5/00

(52) U.S. Cl. CPC B27D 5/003

(57) ABSTRACT

An apparatus is provided that includes a pre-treatment device for pre-treating a surface to be coated, a device for inducing a relative movement between the pre-treatment device and the workpiece, and at least one printing device. The printing device can include at least one digital print head. The pre-treatment device is configured to apply a pre-treatment material to the surface of the workpiece to be printed.

### TECHNICAL FIELD

The invention relates to an apparatus and a method for coating a surface of a workpiece, in particular a narrow side of a plate-shaped workpiece.

### PRIOR ART

Narrow sides of plate-shaped workpieces made of wood or wood materials are often sealed with a so-called edgeband. The edgeband may, for example, be a veneer strip or a strip made of a plastic material. Such a measure is in particular necessary if the plate-shaped workpiece is a chipboard or if, in general, it is a workpiece with a core layer that is to be protected or concealed for optical reasons and has comparatively open-pored structures on the narrow side.

Conventional edgebands have a defined width. An edgeband having a specific width is thus used with a workpiece having a corresponding thickness. In order to increase variability, edgebands with different widths and different patterns are therefore kept in stock. However, this leads to an increased logistical effort.

EP 1 726 443 A1 is, for example, known in this context, which describe s an apparatus and a method for providing a pattern on the narrow side of plate-shaped workpieces. The apparatus comprises a stationary printing unit with at least one inkjet print head, a conveying device and a detection device for detecting the dimensions and/or position of the narrow side to be provided with a pattern. This apparatus avoids the need for re-adjustment each time the component dimensions change. Instead, during continuous operation, for example, components with a wide range of dimensions can be provided with a pattern without stopping operation of the apparatus. An improved quality of the patterning is also achieved with the cited apparatus. Owing to the individual detection of each workpiece, it is thus ensured that only the narrow sides are actually provided with a pattern and that, for example, the top or bottom sides of the workpieces are not undesirably provided with a pattern.

### Subject Matter of the Invention

The object of the invention is to provide an apparatus and a method for providing a surface of a workpiece, in particular a narrow side of a workpiece, with a high quality coating, whereby a high variability should be achieved.

The invention provides such an apparatus. Further embodiments are specified in the dependent claims. The invention furthermore relates to a method according to claim 12. Features of the method as well as further embodiments thereof may be used within the scope of the apparatus. The same applies to features of the apparatus and the preferred further developments thereof, which may be used within the scope of the method.

The apparatus according to the invention is suitable for coating a surface of a workpiece. The surface is preferably a narrow side of a plate-shaped workpiece. The apparatus comprises: at least one pre-treatment device for pre-treating a surface to be coated, a device for inducing a relative movement between the pre-treatment device and the workpiece, and at least one printing device, in particular an inkjet printing device, the printing device (30) comprising at least one digital print head. The print head may be configured as an inkjet print head. It is furthermore provided that the pre-treatment device is configured to apply a pre-treatment material to the surface of the workpiece to be printed.

Advantages of the invention are in particular that the coating of a workpiece can be carried out with a high variability and quality of the surface. The logistics associated with coating narrow sides are additionally also simplified, thus reducing the production costs. Furthermore, the user of the apparatus/method is given the opportunity to influence the design and quality of the coating of the workpiece.

In one embodiment, it is provided that the pre-treatment device is configured to apply a lacquer, a hot-melt adhesive, a two-component material or a thermoplastic material. The pre-treatment material (for example lacquer, hot-melt adhesive, two-component material or thermoplastic material) is suitable for sealing pores on the surface of the workpiece and/or levelling out any unevenness so that a high-quality result can be achieved in a subsequent step for coating the surface of the workpiece.

A thermoplastic material can be applied to a workpiece in a heated state and subsequently cures. The curing process can be accelerated, for example, by a cooling device. A two-component material has proven to be particularly advantageous since this material is self-curing.

The pre-treatment device may comprise an activation device, in particular a UV activation device, to achieve rapid curing of a pre-treatment material, in particular if it is a UV coating or UV hot-melt adhesive.

The pre-treatment device preferably comprises a nozzle, in particular a slot nozzle, and a scraper device for smoothing the material discharged from the nozzle. A high-quality pre-treatment result can thus be achieved.

According to a further embodiment, the pre-treatment device comprises one application nozzle/spray nozzle or a plurality of application nozzles. A contactless and at the same time uniform application of a pre-treatment material can take place in this manner.

It is furthermore possible to apply different pre-treatment materials to the surface of the workpiece, e.g., a curing agent in the peripheral area of the surface in the case of a two-component material. Alternatively or additionally, dyes can be added in a targeted manner.

According to a further embodiment, it is provided that the apparatus additionally comprises a detection device for detecting a property of the surface to be coated. A control device of the apparatus may furthermore be configured to control with and/or without feedback the pre-treatment device and/or the printing device based on the detection result of the detection device. Intelligent monitoring can therefore be provided to a certain extent, providing a self-adjusting system in the case of control with feedback.

The detection device in particular comprises a first detection module arranged and configured to detect the surface to be coated before pre-treatment. In the case of a pass-through machine, the first detection module is thus arranged upstream of the pre-treatment module in the throughput direction. By means of the first detection module, differences in the bulk density and/or porosity of the surface to be coated can be determined. This information can be used to influence the pre-treatment in a targeted manner.

Alternatively or additionally, the detection device comprises a second detection module that is arranged and configured to detect the surface to be coated after pre-treatment. In the case of a pass-through machine, the second detection module is arranged downstream of the pre-treatment module in the throughput direction.

The printing device comprises at least one print head, preferably a plurality of print heads. In one embodiment, the nozzles of the print head have a diameter in the range of 2 μm to 200-300 μm, preferably in the range of 2 μm to 100 μm, particularly preferred in the range of 2 μm to 12 μm.

If the printing device comprises a plurality of print heads, as is provided according to a preferred embodiment, each print head can apply a coating layer to the workpiece in such a manner that a multilayer structure is formed, starting from the surface pre-treated with the pre-treatment device.

It is thereby also possible to assign specific functions to specific layers of the multilayer structure. In particular, an outermost layer may be configured as a protective layer formed from a particularly resistant material. If this outermost layer is transparent, a decorative layer may be formed underneath this protective layer. Layers can furthermore b e provided that give the entire coating a specific thickness that is coordinated with the design of the coating layer present on the broad side. According to a further embodiment, an electrically conductive material may be provided in one of the layers.

The print heads of the printing device each preferably comprise a separate material store. The print heads can accordingly be supplied with different materials.

The print heads of the printing device may have a variable print height. Workpieces having different thicknesses, for example, can therefore be printed on a narrow surface.

The invention furthermore relates to a method for coating a surface of a workpiece, such as in particular a narrow side of a plate-shaped workpiece. An apparatus according to one of the preceding claims may be used within the context of the method. The method comprises the steps of: Pre-treating a surface to be coated with a pre-treatment device, inducing a relative movement between the pre-treatment device and the workpiece, and printing on the pre-treated surface by means of one or more print heads.

A material discharged by the pre-treatment device is preferably a UV lacquer, a UV hot-melt adhesive, a two-component material or a thermoplastic material. A UV lacquer or UV hot-melt adhesive can be cured in particular by means of a UV source. The surface pre-treated in this manner can thus be printed on relatively quickly. A thermoplastic material can be applied to a workpiece in a heated state and subsequently cures. The curing process can be accelerated, for example, by a cooling device. A two-component material has proven to be particularly advantageous since a two-component material is self-curing.

It is provided in a further embodiment of the method that a material discharged from at least one of the print heads is PVC (polyvinyl chloride), PP (polypropylene), ABS (acrylonitrile-butadiene-styrene copolymer), wood-plastic composite (WPC) or acrylic resin.

The surface preferably has a profile, for example one or more radii and/or chamfers. It can thereby be provided that the profile is provided into the workpiece by means of a machining device, such as a milling cutter, and that this is followed by the pre-treatment step.

In a further embodiment, a property of the surface to be coated is detected before or after pre-treatment. Based on the detection result, the pre-treatment device and/or the print head(s) can be controlled with and/or without feedback (in particular by means of a control device).

### BRIEF DESCRIPTION OF THE DRAWING

FIG. 1 is a schematic view of an apparatus according to an embodiment of the invention.

### DETAILED DESCRIPTION OF THE PREFERRED EMBODIMENT

A preferred embodiment of an apparatus according to the invention will be explained by means of the enclosed FIGURE. Modifications of individual features cited in this context may each be individually combined to form further embodiments of the invention. Although both the apparatus described below and the corresponding method are merely to b e understood as examples and should not be seen as limiting, features of the described embodiment may also be used to further characterise the apparatus and method cited in the claims.

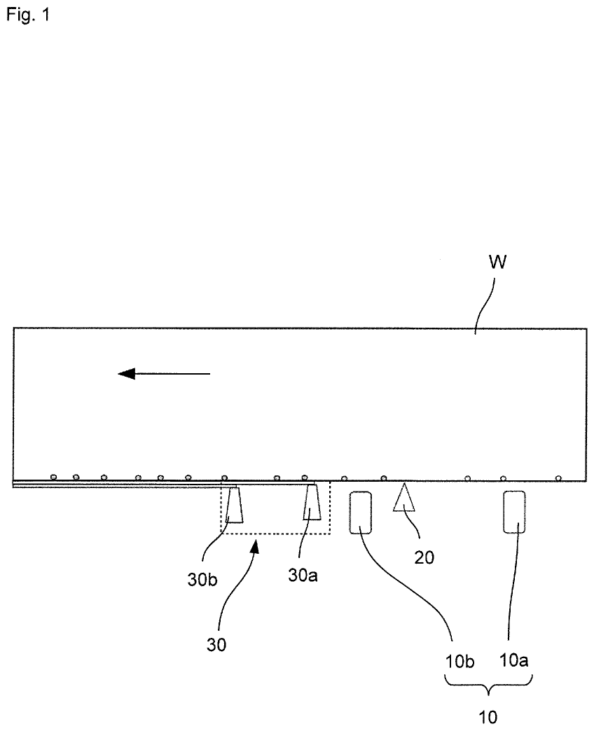

Shown in FIG. 1 is a schematic illustration of an apparatus with which plate-shaped workpieces can be provided with a coating on the narrow side thereof. The cited plate-shaped workpieces are, for example, workpieces made of wood, wood materials or composites, in particular chipboards, MDF boards or the like.

A coating is to be applied to the narrow side of such workpieces during processing in order to treat the narrow side. The main side, also called the broad side, either has a coating layer or does not require a further coating.

A workpiece W is moved in a horizontal direction by means of the apparatus. The direction of movement is indicated by an arrow in the enclosed FIGURE. For this purpose, the apparatus comprises a conveying device, such as a transport belt, a conveyor belt or a conveyor chain. A workpiece may also be moved by means of a robot.

The apparatus furthermore comprises a pre-treatment device 20 that is configured to apply a pre-treatment material to the narrow side of the workpiece W to be coated. For this purpose, the pre-treatment device 20 comprises a nozzle (in particular a slot nozzle) and a scraper device for smoothing the material discharged from the nozzle. Alternatively or additionally, the pre-treatment device may comprise a spray nozzle. The pre-treatment material is used to level out pores and any unevenness of a narrow side of the workpiece W and to provide a flat and even surface.

In particular a UV lacquer, a UV hot-melt adhesive, a two-component material or a thermoplastic material have proven to be advantageous as pre-treatment materials, whereby in particular a UV lacquer and a UV hot-melt adhesive may b e cured by means of a UV source. A thermoplastic material can be applied to a workpiece in a heated state and subsequently cures. The curing process can be accelerated, for example, by a cooling device. A two-component material can be mixed from two components before application to the workpiece so that a self-curing process is started.

The pre-treatment device 20 is accordingly configured to apply at least one of the cited materials to the narrow side of the workpiece W and to thus prepare the narrow side for a subsequent processing step.

The narrow side of the workpiece W provided with the cured pre-treatment material provides a surface that can be treated, in particular printed, in the course of further processing. Such a surface has a similarly hard structure to other sides of the workpiece.

The apparatus furthermore comprises a printing device 30 having a plurality of print heads 30a, 30b. Two print heads are provided in the present embodiment, though a larger number (number n) of print heads may also be used. The print heads 30a, 30b each apply a coating layer to the workpiece W in such a manner that a multilayer structure is formed, starting from the surface pre-treated by the pre-treatment device 20.

The print heads are configured as inkjet print heads, the nozzles of which have a diameter in the range of approximately 2 μm to 12 μm.

It is thereby possible to assign specific functions to specific layers of the multilayer structure. In particular, an outermost layer may be configured as a protective layer formed from a particularly resistant material. If this outermost layer is transparent, a decorative layer may be formed underneath this protective layer. Layers can furthermore b e provided that give the entire coating a specific thickness that is coordinated with the design of the coating layer present on the broad side. An electrically conductive material may be provided in one of the layers.

Depending on the use, the surfaces to be coated may already be provided with a profile. The print heads 30a, 30b of printing device 30 are accordingly also adapted to such a profile in order to ensure an equal distance between the nozzles of the print heads and the surface to be coated.

The apparatus furthermore comprises a detection device 10 having a first detection module 10a and a second detection module 10b. In the throughput direction, the first detection module 10a is arranged upstream of the pre-treatment device 20, whereas the second detection module 10b is arranged downstream of the pre-treatment device 20. The detection modules 10a, 10b are configured to perform contactless detection of a surface.

The first detection module 10a detects a surface of the workpiece W that is still untreated, and setting or adjustment of the pre-treatment device 20 is carried out based on the detection result. The amount of pre-treatment material to be dosed can be set or changed, for example. It is ensured in this manner that any pores or unevenness on the narrow side of the workpiece W are levelled out and/or filled.

By means of the second detection module 10b the work result of the pre-treatment device 20 can be checked to ensure a high-quality surface before printing with the printing device 30.

The apparatus may further comprise a machining device for machining the surface of a workpiece W. This machining device can be used to provide a profile into the surface of a workpiece W, if required, before a pre-treatment material is applied to the narrow side of the workpiece W to be coated by means of the pre-treatment device 20. According to a further embodiment, the machining device may be omitted, in particular if workpieces that have a flat narrow side or have already been provided with a profile are to be coated using the apparatus.

Processing of a plate-shaped workpiece is carried out as explained below.

The workpiece W is first of all placed on a conveying device of the apparatus and moved in the direction of movement. When placing or moving the workpiece W, it is aligned and conveyed into the region of the first detection module 10a of the detection device 10. The first detection module 10a determines whether the evaluated narrow side of the workpiece has any unevenness and/or pores. A quantitative detection of the unevenness and/or pores is thereby also carried out.

The result determined by the first detection module 10a is transmitted to the control device of the apparatus, the control device being configured to make adjustments to the pre-treatment device 20 arranged downstream in the throughput direction based on the detection result.

Using the pre-treatment device 20, the surface of the workpiece W is then pre-treated by applying a pre-treatment material to the surface of the workpiece. This pre-treatment material is preferably a UV lacquer, a UV hot-melt adhesive or a thermoplastic material, which is discharged by means of a nozzle and is distributed and smoothed on the surface of the workpiece W by means of a smoothing device.

A second detection module 10b is provided downstream of the pre-treatment device 20 in the throughput direction, which detects the surface pre-treated by the pre-treatment device 20. The detection result is transmitted to the control device of the apparatus. The control device is configured to perform feedback control of the pre-treatment device 20 based on the detection result of the second detection module 10b, e.g. to reduce or increase the amount discharged by the pre-treatment device 20.

The workpiece W subsequently enters the region of the printing device 30 that comprises a plurality of print heads. By using a plurality of print heads 30a, 30b, a multilayer structure is generated on the narrow side of the workpiece W to treat the narrow side of the workpiece W.

1. An apparatus for coating a surface of a workpiece comprising:
at least one pre-treatment device for pre-treating a surface to be coated,
a device for inducing a relative movement between the pre-treatment device and the workpiece, and
at least one printing device the printing device comprising at least one digital print head, wherein
the pre-treatment device is configured to apply a pre-treatment material to the surface of the workpiece to be printed.

2. The apparatus according to claim 1, wherein the pre-treatment device is configured to apply a lacquer, a hot-melt adhesive, a two-component material or a thermoplastic material.

3. The apparatus according to claim 1, wherein the pre-treatment device comprises a UV activation device.

4. The apparatus according to claim 1, wherein the pre-treatment device comprises a nozzle and a scraper device for smoothing the pre-treatment material discharged from the nozzle.

5. The apparatus according to claim 1, further comprising a detection device for detecting a property of the surface to be coated, wherein a control device of the apparatus is configured to control with and/or without feedback the pre-treatment device and/or the printing device based on a detection result of the detection device.

6. The apparatus according to claim 5, characterised in that the detection device comprises:
a first detection module arranged and configured to detect the surface to be coated before pre-treatment, and/or
a second detection module that is arranged and configured to detect the surface after pre-treatment.

7. The apparatus according to claim 1, wherein the print head has a nozzle with a diameter in the range of 2 μm to 300 μm.

8. The apparatus according to claim 1, wherein the printing device comprises a plurality of print heads.

9. The apparatus according to claim 8, wherein the print heads of the printing device each have a separate material store.

10. The apparatus according to claim 8, wherein the print heads of the printing device have a variable print height.

11. The apparatus according to claim 1, further comprising a machining device for machining the surface of a workpiece.

12. A method for coating a surface of a workpiece comprising:
pre-treating a surface to be coated using a pre-treatment device,
inducing a relative movement between the pre-treatment device and the workpiece, and
printing on the pre-treated surface by means of one or more digital print heads.

13. The method according to claim 12, wherein a material discharged by the pre-treatment device is a UV lacquer, a UV hot-melt adhesive, a two-component material or a thermoplastic material.

14. The method according to claim 12, wherein a material discharged from the print head or from at least one of the print heads is polyvinyl chloride, polypropylene, ABS, wood-plastic composite or acrylic resin.

15. The method according to claim 12, wherein the surface has a profile.

16. The method according to claim 12, further comprising the step of detecting of a property of the surface to be coated before or after pre-treatment, wherein, based on a detection result, the pre-treatment device and/or the print head(s) are controlled with and/or without feedback.

17. The apparatus according to claim 1, wherein the printing device is an inkjet printing device.

18. The apparatus according to claim 4, wherein the nozzle is a slot nozzle or spray nozzle.

19. The apparatus according to claim 7, wherein the nozzle of the print head has a diameter in the range of 2 μm to 200 μm, in the range of 2 μm to 100 μm, or in the range of 2 μm to 12 μm.

20. The method according to claim 12, wherein the method is used for coating a narrow side of a plate-shaped workpiece.
